(19) United States
(12) Patent Application Publication
(10) Pub. No.: US 2026/0066712 A1
(43) Pub. Date: Mar. 5, 2026

(54) ELECTRONIC DEVICE AND METHOD OF DRIVING THE SAME

(71) Applicant: SAMSUNG ELECTRONICS CO., LTD., Suwon-si (KR)

(72) Inventors: Mingi SONG, Suwon-si (KR); Sehyoung PARK, Suwon-si (KR); Woong LEE, Suwon-si (KR); Kyungmin PARK, Suwon-si (KR); Juhyang LEE, Suwon-si (KR)

(21) Appl. No.: 19/284,547

(22) Filed: Jul. 29, 2025

Related U.S. Application Data
(63) Continuation of application No. PCT/KR2025/011118, filed on Jul. 25, 2025.

(30) Foreign Application Priority Data
Aug. 27, 2024 (KR) 10-2024-0114902
Jan. 6, 2025 (KR) 10-2025-0001734

(51) Int. Cl. H02J 50/80; H02J 50/12; H02J 50/60; H02J 50/90

(52) U.S. Cl. CPC H02J 50/80; H02J 50/12; H02J 50/60; H02J 50/90

(57) ABSTRACT

Embodiments of the disclosure relate to an electronic device for wirelessly transmitting or wirelessly receiving electric power and a method of driving the same, which may output a first ping and/or a second ping through a coil, count an N value indicating a cumulative number of times the first ping and/or the second ping has been output, if the N value is less than a specified first threshold and if a response to the first ping is received from the external device, perform first negotiation communication with the external device for first wireless charging, the first wireless charging being performed based on an alignment state between the electronic device and the external device using a magnet, if the N value is less than the first threshold and if a response to the second ping is received from the external device, output the first ping and/or the second ping again, and, if the N value is greater than or equal to the first threshold, perform second negotiation communication with the external device for second wireless charging independent of recognizing the magnet.

### CROSS-REFERENCE TO RELATED APPLICATIONS

This application is a continuation of International Application No. PCT/KR2025/011118 designating the United States, filed on Jul. 25, 2025, in the Korean Intellectual Property Receiving Office and claiming priority to Korean Patent Application Nos. 10-2024-0014902, filed on Aug. 27, 2024, and 10-2025-0001734, filed on Jan. 6, 2025, the disclosures of each of which are incorporated by reference herein in their entireties.

### BACKGROUND

### Field

The disclosure relates to an electronic device for wirelessly transmitting or wirelessly receiving electric power and a method of driving the same.

### Description of Related Art

Wireless Power Consortium (WPC) is an organization established for the purpose of establishing and distributing Qi, a standard for wireless charging. According to the Qi standard, baseline power profile (BPP) supports wireless charging of up to about 5 W, and extended power profile (EPP) supports fast wireless charging of up to about 15 W.

According to BPP, the operation for wirelessly charging the battery of the power receiving device between the power receiving device (e.g., smartphone) and the power supply device (e.g., wireless charging pad) may include a signal strength (SS) identification (ID) step, a configuration step, and a power transfer step. In the SSID step, the power supply device may identify the power receiving device, based on the response of the power receiving device to the ping signal (or wakeup signal) transmitted by the power supply device. In the configuration step, the power supply device may configure the power value to be transmitted to the power receiving device through data communication with the power receiving device. In the power transmission step, the power supply device may transmit power of the configured value to the power receiving device through the coil.

According to EPP, the wireless charging operation may further include a negotiation step and a calibration step performed after the configuration step. After the calibration step is completed, the power transmission step may be performed. In the negotiation step, the power supply device may identify the quality of the electrical coupling between the transmitting coil and the receiving coil and negotiate with the power receiving device for the maximum power capable of being supplied to the power receiving device. In the calibration step, the power supply device may measure the power loss (e.g., friendly metal loss) and, based on the measured power loss, calibrate the value of the power to be supplied to the power receiving device, thereby increasing the accuracy of foreign object detection (FOD).

The above-described information may be provided as related art for the purpose of helping understand the disclosure. No assertion or determination is made as to whether or not any of the above is applicable as prior art in connection with the disclosure.

Recently, magnetic power profile (MPP) technology has been introduced separately from BPP and EPP. Unlike BPP and EPP, MPP supports wireless charging based on the alignment state between the power receiving device (e.g., smartphone) and the power supply device (e.g., wireless charging pad) using magnets.

MPP has the advantage of performing wireless charging with high efficiency by fixing the coil of the power receiving device and the coil of the power supply device to the optimal positions using magnets. However, MPP may have a problem in which the charging efficiency is lowered when the positions of the magnets are inaccurate. For example, users generally attach cover accessories to their smartphones for the purpose of protecting their smartphones and expressing their individuality, and the cover accessories may be mass-produced to include magnets in consideration of the MPP specifications. However, if the cover accessory is not a genuine product of the manufacturer, the magnets of the cover accessory may cause process errors, which may cause repeated charging errors (e.g., charging failures) during wireless charging according to the MPP specifications.

### SUMMARY

Embodiments of the disclosure may provide an electronic device that support wireless charging by fixing a coil of a power receiving device and a coil of a power supply device to optimal positions using magnets, and also performs wireless charging without considering the magnets when the coil of the power receiving device and the coil of the power supply device are not aligned at the optimal positions, and a method of driving the same.

An electronic device according to an example embodiment of the present disclosure may include: a coil, a transmitting integrated circuit (IC) configured to wirelessly transmit power to an external device through the coil, and a controller, comprising circuitry, wherein the controller may be configured to cause the electronic device to: output a first ping and/or a second ping through the coil, count an N value indicating a cumulative number of times the first ping and/or the second ping has been output, based on the N value being less than a specified first threshold and based on a response to the first ping being received from the external device, perform first negotiation communication with the external device for first wireless charging, the first wireless charging being performed based on an alignment state between the electronic device and the external device using a magnet, based on the N value being less than the first threshold and based on a response to the second ping being received from the external device, output the first ping and/or the second ping again, and, based on the N value being greater than or equal to the first threshold, perform second negotiation communication with the external device for second wireless charging independently of recognizing the magnet.

An electronic device according to an example embodiment of the present disclosure may include: a coil, a wireless charging circuit configured to wirelessly receive power from an external device through the coil, at least one processor, comprising processing circuitry, and a memory configured to store instructions, wherein at least one processor, individually and/or collectively, is configured to execute the instructions and to cause the electronic device to: receive a ping of the external device through the coil, upon receiving the ping, identify whether at least one processor is in an awake state, based on at least one processor being in an awake state, determine whether a cover accessory including a magnet is coupled to the electronic device, based on the cover accessory being coupled to the electronic device, count an N value indicating a cumulative number of times the ping has been received, based on the N value being less than a specified first threshold, perform first negotiation communication with the external device for first wireless charging, the first wireless charging being performed based on an alignment state of the electronic device and the external device using a magnet, and, based on the N value being greater than or equal to the first threshold, perform second negotiation communication with the external device for second wireless charging independent of recognizing the magnet.

A method of driving an electronic device configured to wirelessly transmit power to an external device according to an example embodiment of the present disclosure may include: outputting a first ping and/or a second ping sequentially through a coil, counting an N value indicating a cumulative number of times the first ping and/or the second ping has been output, based on the N value being less than a specified first threshold and based on a response to the first ping being received from the external device, performing first negotiation communication with the external device for first wireless charging, the first wireless charging being performed based on an alignment state between the electronic device and the external device using a magnet, based on the N value being less than the first threshold and based on a response to the second ping being received from the external device, outputting the first ping and/or the second ping again, and, based on the N value being greater than or equal to the first threshold, performing second negotiation communication with the external device for second wireless charging independently of recognizing the magnet.

A method of driving an electronic device configured to wirelessly receive power from an external device according to an example embodiment of the present disclosure may include: receiving a ping of the external device through a coil, upon receiving the ping, identifying whether a processor is in an awake state, based on the processor being in an awake state, determining whether a cover accessory including a magnet is coupled to the electronic device, based on the cover accessory being coupled to the electronic device, counting an N value indicating a cumulative number of times the ping has been received, based on the N value being less than a first threshold, performing first negotiation communication with the external device for first wireless charging, the first wireless charging being performed based on an alignment state of the electronic device and the external device using a magnet, and, based on the N value being greater than or equal to the first threshold, performing second negotiation communication with the external device for second wireless charging independent of recognizing the magnet.

According to various example embodiments of the disclosure, it is possible to prevent and/or reduce the issue of repeated charging errors (e.g., charging failure) during wireless charging by performing wireless charging without considering the magnets when the coil of the power receiving device and the coil of the power supply device are not aligned at the optimal positions.

In addition, various effects that may be directly or indirectly identified through this disclosure may be provided.

### BRIEF DESCRIPTION OF THE DRAWINGS

The above and other aspects, features, and advantages of certain embodiments of the present disclosure will be more apparent from the following detailed description, taken in conjunction with accompanying drawings in which:

FIG. 1 is a block diagram illustrating an example electronic device in a network environment according to various embodiments;

FIG. 2 is a block diagram illustrating an example configuration of a wireless charging system according to various embodiments;

FIG. 3 is a flowchart illustrating an example operation of a power supply device according to various embodiments;

FIG. 4 is a diagram illustrating an example of a scenario in which a power supply device performs MPP charging according to various embodiments;

FIG. 5 is a diagram illustrating an example of a scenario in which a power supply device performs BPP charging (or EPP charging) according to various embodiments;

FIG. 6 is a flowchart illustrating an example operation in which a power supply device determines whether to perform MPP charging, based on a K value indicating an alignment state of coils according to various embodiments;

FIG. 7 is a diagram illustrating an example of a scenario in which a power supply device performs MPP charging, based on a K value greater than or equal to a threshold, according to various embodiments;

FIG. 8 is a diagram illustrating an example of a scenario in which a power supply device performs BPP charging (or EPP charging), based on a K value less than a threshold, according to various embodiments;

FIG. 9 is a graph illustrating an example of a correlation between a gain of a wireless charging system and a K value according to various embodiments;

FIG. 10 is a diagram illustrating an example of a notification output from a power receiving device according to various embodiments;

FIG. 11 is a flowchart illustrating an example operation of a power receiving device according to various embodiments; and

FIG. 12 is a signal flow diagram illustrating an example operation of a wireless charging system according to various embodiments.

### DETAILED DESCRIPTION

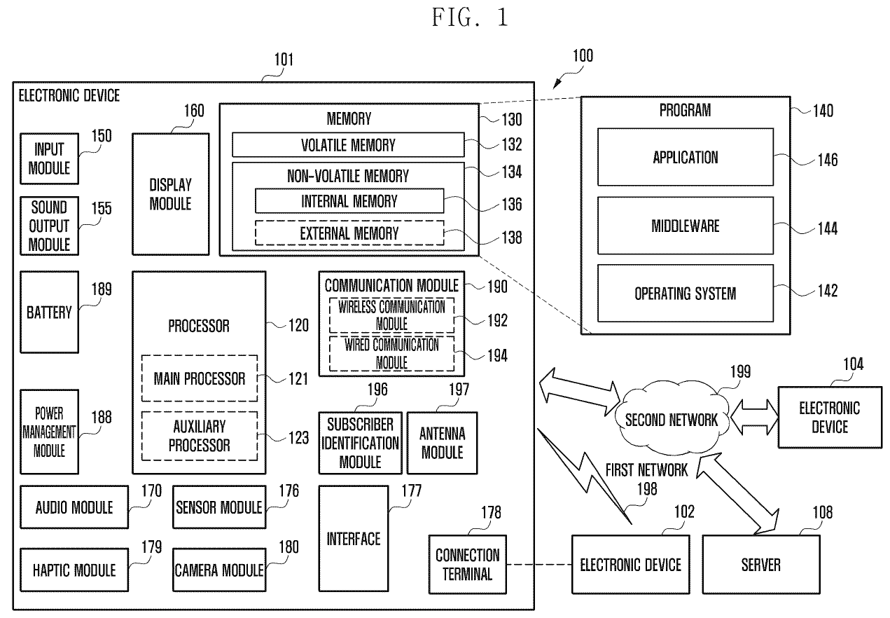

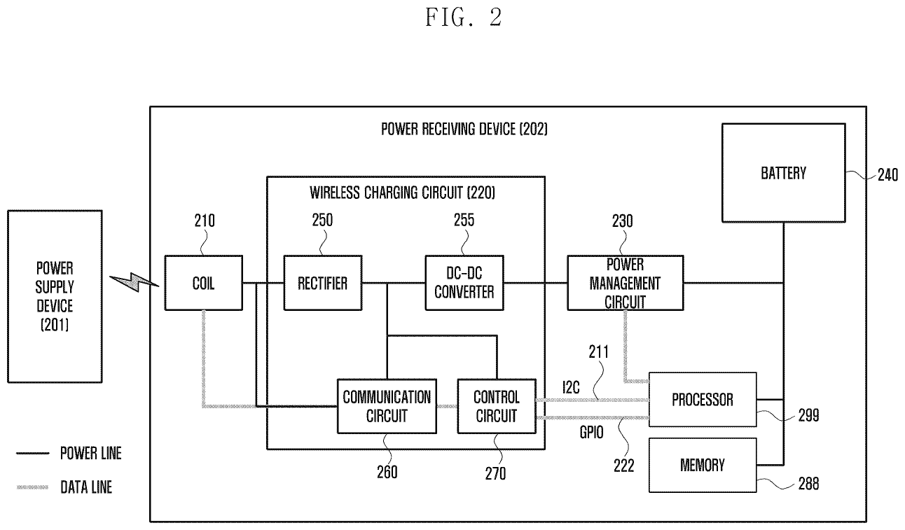

Various example embodiments described with reference to the drawings of the disclosure may be independently configured as an embodiment. For example, the embodiment in FIG. 1 and the embodiment in FIG. 2 may be configured independently of each other. Each of the embodiments described with reference to the drawings of the disclosure may be performed independently as an embodiment. For example, the embodiment in FIG. 1 and the embodiment in FIG. 2 may be performed independently of each other.

Various example embodiments of the embodiments described with reference to the drawings of the disclosure may be combined and configured. For example, at least a portion of the embodiment in FIG. 1 and at least a portion of the embodiment in FIG. 2 may be combined and configured. At least two embodiments of the embodiments described with reference to the drawings of the disclosure may be combined and performed. For example, at least a portion of the embodiment in FIG. and at least a portion of the embodiment in FIG. 2 may be combined and performed.

In the case where at least two of the embodiments described with reference to the drawings of the disclosure are combined, at least some of the configurations and/or at least some of the operations included in the respective embodiments may be omitted. For example, if the embodiment in FIG. 1 and the embodiment in FIG. 2 are combined, at least some of the configurations and/or at least some of the operations included in the embodiment in FIG. 1 may be omitted, and at least some of the configurations and/or at least some of the operations included in the embodiment in FIG. 2 may be omitted.

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

FIG. 2 is a block diagram illustrating an example configuration of a wireless charging system according to various embodiments.

Referring to FIG. 2, a wireless charging system according to an embodiment may include a power supply device (e.g., including a power supply) 201 (e.g., the electronic device 102 in FIG. 1) and a power receiving device (e.g., including circuitry) 202 (e.g., the electronic device 101 in FIG. 1).

The power supply device 201 (e.g., the electronic device 102 in FIG. 1) may wirelessly transmit power. The power receiving device 202 (e.g., the electronic device in FIG. 1) may wirelessly receive power. The wireless charging system may perform wireless charging based on a designated charging protocol. The designated charging protocol may include BPP (baseline power profile), EPP (extended power profile), and MPP (magnetic power profile) according to the Qi standard.

The wireless charging system according to an embodiment may support BPP, thereby supporting general wireless charging (in other words, low-speed wireless charging) of up to about 5 W. BPP may be low-speed wireless charging based on one-way communication in which data is transmitted only from the power receiving device 202 to the power supply device 201. During wireless charging according to BPP, the power supply device 201 may wirelessly transmit power of up to about 5 W to the power receiving device 202.

The wireless charging system according to an embodiment may support EPP, thereby supporting high-speed wireless charging of up to about 15 W. EPP may be high-speed wireless charging based on two-way communication between the power supply device 201 and the power receiving device 202. During wireless charging according to EPP, the power supply device 201 may wirelessly transmit power of up to about 15 W to the power receiving device 202.

The wireless charging system according to an embodiment may support high-speed wireless charging of about 15 W or more based on the alignment state of the power supply device 201 and the power receiving device 202 using magnets by supporting MPP. When the wireless charging system operates in MPP charging mode, higher power may be wirelessly transmitted than when operating in EPP charging mode. In wireless charging according to MPP, the power supply device 201 and the power receiving device 202 may identify the alignment state therebetween using the magnets, and then the power supply device 201 may wirelessly transmit power of about 15 W or more to the power receiving device 202.

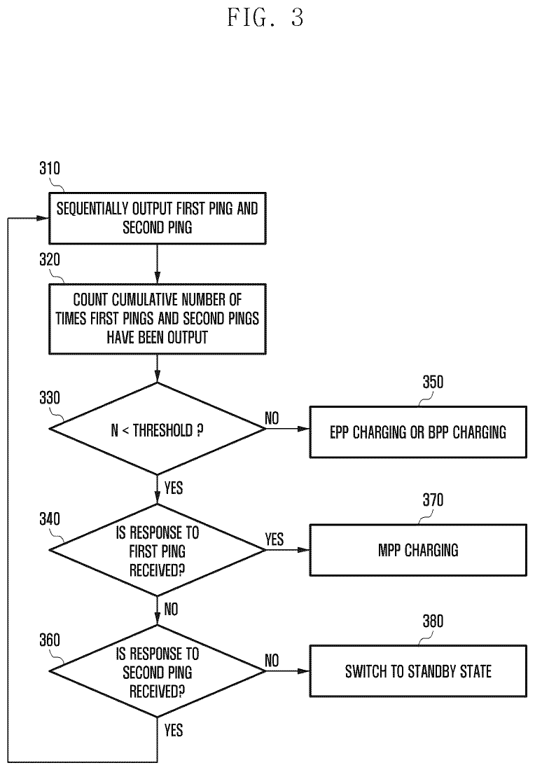

The wireless charging system according to an embodiment may attempt wireless charging based on MPP when supporting MPP but, if the optimal alignment state using the magnets is not identified between the power supply device 201 and the power receiving device 202, perform wireless charging according to EPP or BPP, thereby preventing and/or reducing recurrence of charging errors. That the wireless charging system according to an embodiment attempts wireless charging based on MPP may indicate that it attempts wireless charging based on MPP first. The operation of each of the power supply device 201 and the power receiving device 202 according to an embodiment of the disclosure will be described in greater detail below with reference to FIGS. 3, 4, 5, 6, 7, 8, 9, 10 and 11.

According to an embodiment, the power receiving device 202 may include a coil (or conductive pattern) 210, a wireless charging circuit 220, a power management circuit 230, a battery 240 (e.g., the battery 189 in FIG. 1), a memory 288 (e.g., the memory 130 in FIG. 1), and a processor (e.g., including processing circuitry) 299 (e.g., the processor 120 in FIG. 1). According to an embodiment, the power supply device 201 may include components that are identical or substantially identical to at least some of the components of the power receiving device 202. For example, the power supply device 201 may include a coil that is at least partially similar to the coil 210, which will be described with reference to FIG. 2, a transmitting IC configured to wirelessly transmit power through the coil, and a controller for controlling the overall operation of the power supply device 201.

According to an embodiment, the wireless charging circuit 220 (e.g., the circuit configured in the power management module 188 in FIG. 1) may wake up by a power signal (e.g., a digital ping) received from the power supply device 201 via the coil 210. The wireless charging circuit 220 may be configured to perform a given function (e.g., charging the battery 240 and communicating with the power supply device 201 for the same) using the power supplied from the power supply device 201. According to an embodiment, the wireless charging circuit 220 may include a rectifier 250, a DC-DC converter 255, a communication circuit 260, and a control circuit 270. According to an embodiment, the rectifier 250, the DC-DC converter 255, the communication circuit 260, and the control circuit 270 may be configured as a single IC (integrated circuit). For example, one IC may be configured to perform operations for rectification, DC-DC converting, communication, and control of the wireless charging circuit 200.

According to an embodiment, the control circuit 270 may be configured in a separate IC from at least one of the communication circuit 260, the rectifier 250, and the DC-DC converter 255.

According to an embodiment, at least one of the rectifier 250, the DC-DC converter 255, the communication circuit 260, and the control circuit 270 may be configured in a single IC together with the power management circuit 230.

According to an embodiment, the power management circuit 230 may include a converter for supplying power to the battery 240 and a load (e.g., the processor 299). For example, it may include a buck-boost charger and/or a direct charger. The direct charger may be a switched capacitor voltage divider (SCVD) converter and may change the input voltage and output voltage in a ratio of n:1. The power management circuit 230 may include a power management integrated circuit (PMIC) for supplying appropriate voltage and current to various loads (e.g., a processor, a display, or a sensor).

The memory 288 (e.g., the memory 130 in FIG. 1) and the processor 299 (e.g., the processor 120 in FIG. 1) may be load circuits (in other words, a system) that are driven using power supplied from the wireless charging circuit 220 and/or power supplied from the battery 240 through the power management circuit 230. In addition, the load circuits may include a display (e.g., the display module 160 in FIG. 1) and/or a communication circuit (e.g., the communication module 190 in FIG. 1).

The coil 210 may be a spiral-type coil wound multiple times in a clockwise or counterclockwise direction. When the power receiving device 202 is placed on a charging pad of the power supply device 201, the coil 210 may be aligned parallel to the coil of the power supply device 201. The power receiving device 202 may receive power from the power supply device 201 through electrical coupling between a transmitting coil (e.g., the coil of the power supply device 201) and a receiving coil (e.g., the coil 210). The coil 210 may resonate at the same frequency as the coil of the power supply device 201 resonates. The power receiving device 202 may further include a resonant circuit to cause the coil 210 to resonate at a specific frequency (e.g., a frequency specified in the WPC (Wireless Power Consortium) standard). The coil may be used as an antenna for data communication (e.g., in-band communication), in addition to receiving power. According to an embodiment, the power receiving device 202 may include a plurality of coils 210.

The rectifier 250 may be configured to rectify (e.g., convert alternating current (AC) to direct current (DC)) the power received from the power supply device through the coil 210 and output it to the DC-DC converter 255. The DC-DC converter (e.g., LDO (low dropout)) 255 may convert the voltage value (in other words, voltage level) of the power rectified by and received from the rectifier 250 into a designated voltage value and output it to the power management circuit 230.

The power management circuit 230 (e.g., the circuit configured in the power management module 188 in FIG. 1) may control the voltage value and/or current value (in other words, current level) of the power received from the wireless charging circuit and supply it to the battery 240 and the load circuit. For example, the power management circuit 230 may include a buck converter that down-converts the voltage of the power supplied from the wireless charging circuit 220 and outputs it, and/or a boost converter that up-converts the voltage of the received power and outputs it.

The communication circuit 260 may be configured to perform data communication (e.g., in-band communication) with the power supply device 201 through the coil 210 using power supplied from the power supply device 201 through the rectifier 250. For example, the communication circuit 260 may receive data from the control circuit 270 and transmit the received data to the power supply device 201 by embedding it in a power signal received from the power supply device 201. A method of embedding data in the power signal may include a technique of modulating the amplitude and/or frequency of the power signal. For example, the communication circuit 260 may control switching for opening and closing a switch located on an electrical path connecting the coil 210 and the ground of the power receiving device 202, thereby changing the amplitude of the power signal. The communication circuit may demodulate the power signal transmitted from the power supply device 201 to the coil 210 and obtain the data transmitted from the power supply device 201 to the power receiving device 202. The communication circuit 260 may transmit the obtained data to the control circuit 270.

The control circuit 270 may wake up by a power signal (e.g., digital ping) supplied from the power supply device 201 through the rectifier 250. The control circuit 270 may be configured to perform data communication with the processor 299 through a communication interface provided in the power receiving device 202 using the power supplied from the power supply device 201 through the rectifier 250 and to perform communication for charging the battery 240 with the power supply device through the communication circuit 260. For example, the control circuit 270 may obtain information about the charging state from the power supply device 201 through the communication circuit 260 and provide the obtained information to the processor through a first communication interface 211 (e.g., I2C (inter integrated circuit)).

According to an embodiment, the control circuit 270 may configure the charging mode of the wireless charging circuit 220 to an MPP mode or an EPP mode for high-speed charging of the battery 240, based on a signal received from the processor 299 (e.g., microcontroller unit (MCU) or application processor (AP)) through a second communication interface 222 (e.g., general-purpose input/output (GPIO)). The control circuit 270 may configure the charging mode of the wireless charging circuit 220 to a BPP mode, based on a signal received from the processor 299, and the BPP mode may be a mode for charging the battery 240 at a lower speed than the MPP mode or the EPP mode.

FIG. 3 is a flowchart illustrating an example operation of a power supply device 201 according to various embodiments.

The operations illustrated in FIG. 3 may be performed by the controller of the power supply device 201.

At least some of the operations illustrated in FIG. 3 may be omitted. At least some of the operations mentioned with reference to other drawings in the disclosure may be further performed before or after at least some of the operations illustrated in FIG. 3.

According to an embodiment, at least some of the operations illustrated in FIG. 3 may be performed sequentially.

According to an embodiment, at least some of the operations illustrated in FIG. 3 may be performed in parallel (simultaneously).

According to an embodiment, at least some of the operations illustrated in FIG. 3 may be performed in different sequences.

Hereinafter, the operation of the power supply device 201 according to an example embodiment will be described with reference to FIG. 3.

In operation 310, an electronic device 201 (e.g., the power supply device 201 in FIG. 2) according to an embodiment may output a digital ping to wake up an external device 202 (e.g., the power receiving device 202 in FIG. 2). For example, the electronic device 201 may output a digital ping having a frequency of about 128 kHz. The digital ping may include a first ping and a second ping. The electronic device 201 may sequentially output the first ping and the second ping. For example, if a response is not received after outputting the first ping, the electronic device 201 may output the second ping. The output power of the first ping may be lower than the output power of the second ping. The electronic device 201 may adjust the output power by adjusting the duty and voltage of the digital ping. The external device 202 may transmit, to the electronic device 201, a response signal (e.g., signal strength packet (SSP)) to the digital ping. According to an embodiment, the external device may output a response signal in response to the digital ping, and the response signal may include an extended identification data (XID) packet indicating that MPP is supported. For example, if XID is received as a response signal of the external device 202 to the digital ping, the electronic device 201 may determine that the external device 202 supports MPP charging.

The term “MPP charging” used in various embodiments of the disclosure may indicate wireless charging based on the alignment state of the electronic device and the external device 202 using magnets, in which a power supply device 201 (e.g., the power supply device 201 in FIG. 2) may wirelessly transmit power of about 15 W or more to a power receiving device 202 (e.g., the power receiving device 202 in FIG. 2), or may use a different charging mode and a different frequency band (e.g., about 360 kHz). It may be used interchangeably with terms such as “first wireless charging” and “MPP mode.”

The term “first ping” used in various embodiments of the disclosure may indicate a digital ping signal having a lower output power than a second ping, and may be used interchangeably with terms such as “high K ping” or “first digital ping.”

The term “second ping” used in various embodiments of the disclosure may indicate a digital ping signal having a higher output power than the first ping, and may be used interchangeably with terms such as “low K ping” or “second digital ping.”

In operation 320, the electronic device 201 according to an embodiment may count an N value indicating the cumulative number of times the pings (e.g., the first ping and/or the second ping) have been output. After outputting the first ping, the electronic device 201 may obtain a K value indicating the degree to which a coil (e.g., a first coil) of the electronic device 201 and a coil (e.g., a second coil) of the external device 202 are coupled and, if the K value is less than a specific value, increase the N value. The electronic device 201 may receive a response to the second ping and increase the N value when outputting the first ping again. The electronic device 201 may sequentially output the first ping and the second ping, and count the cumulative number of times the first pings and the second pings have been sequentially output. The N value counted by the electronic device 201 may represent the cumulative number of times the electronic device 201 has attempted MPP charging. According to an embodiment, the electronic device 201 may receive a response signal after outputting a ping (e.g., the second ping) and, if it is not in a suitable state to attempt MPP charging, add the cumulative number of outputs, thereby performing the ping output operation again. An increase in the N value counted by the electronic device may indicate an increase in the cumulative number of times the electronic device has attempted MPP charging but failed MPP charging. For example, the electronic device 201 may preferentially attempt MPP charging but, if at least one specified condition is not met, perform operation 310 again to sequentially output the first ping and the second ping. The electronic device 201 may count the N value indicating the cumulative number of repetitions while perform operation 310 again to sequentially output the first ping and the second ping.

According to an embodiment, the electronic device 201 may transmit data about the N value to the external device 202. Accordingly, like the electronic device 201, the external device 202 may also identify the cumulative number of times the MPP charging has been attempted.

In operation 330, the electronic device 201 according to an embodiment may identify whether the N value is less than a specified first threshold. If the N value is less than the specified first threshold (e.g., YES in operation 330), the electronic device 201 may perform operation 340. If the N value is greater than or equal to the specified first threshold (e.g., NO in operation 330), the electronic device 201 may perform operation 350. According to an embodiment, if the N value, indicating the cumulative number of times MPP charging has been attempted, is less than the specified first threshold, the electronic device 201 may repeatedly re-attempt MPP charging. The electronic device 201 may perform operation 340 as an operation for attempting MPP charging.

In operation 340, the electronic device 201 according to an embodiment may identify whether a response signal is received from the external device 202 after outputting the first ping. If a response signal is received from the external device 202 after outputting the first ping (e.g., YES in operation 340), the electronic device 201 may perform operation 370. If a response signal is not received from the external device 202 after outputting the first ping (e.g., NO in operation 340), the electronic device 201 may perform operation 360. If the electronic device 201 receives an extended identification data (XID) packet indicating that MPP is supported from the external device 202 after outputting the first ping, the electronic device 201 may perform operation 370. According to an embodiment, even if each of the electronic device 201 and the external device 202 supports MPP charging, if the magnets for aligning the electronic device 201 and the external device 202 are in a misalignment state, the external device 202 may not output a response signal to the first ping. If a response signal (e.g., XID packet or SSP) is not received from the external device 202 after outputting the first ping, the electronic device 201 may perform operation 360. For example, the electronic device 201 may perform an operation of outputting the second ping in order to receive a response to the second ping.

In operation 350, the electronic device 201 according to an embodiment may perform EPP charging or BPP charging. The electronic device 201 according to an embodiment may perform EPP charging or BPP charging if the N value, indicating the number of times MPP charging has been attempted repeatedly, is greater than or equal to a specified first threshold. For example, if the N value, indicating the cumulative number of times MPP charging has been attempted, is greater than or equal to a specified first threshold, the electronic device 201 may perform EPP charging or BPP charging without attempting MPP charging any more.

The electronic device 201 according to an embodiment, if the N value, indicating the number of times MPP charging has been attempted repeatedly, is greater than or equal to a specified first threshold, may perform second negotiation communication with the external device 202 for EPP charging (e.g., second wireless charging). If the N value, indicating the number of times MPP charging has been attempted repeatedly, is greater than or equal to a specified first threshold, and if the external device 202 does not support EPP charging, the electronic device 201 may perform third communication with the external device 202 for BPP charging (e.g., third wireless charging). Here, the third communication may indicate one-way communication in which the external device 202 requests a specific power or a specific voltage from the electronic device 201.

The term “EPP charging” used in various embodiments of the disclosure may indicate high-speed wireless charging in which a power supply device 201 (e.g., the power supply device 201 in FIG. 2) wirelessly transmits power of up to about 15 W to a power receiving device 202 (e.g., the power receiving device 202 in FIG. 2), and may be used interchangeably with terms such as “second wireless charging” and “EPP mode.”

The term “BPP charging” used in various embodiments of the disclosure may indicate low-speed wireless charging in which a power supply device 201 (e.g., the power supply device 201 in FIG. 2) wirelessly transmits power of up to about 5 W to a power receiving device 202 (e.g., the power receiving device 202 in FIG. 2), and may be used interchangeably with terms such as “third wireless charging” and “BPP mode”.

In operation 350, an electronic device 201 according to an embodiment may identify whether the external device 202 supports EPP charging. If the external device supports EPP charging, the electronic device 201 may perform EPP charging in which power of up to about 15 W is wirelessly transmitted to the external device 202.

In EPP charging, the electronic device 201 may exchange data (e.g., packets) corresponding to identification and configuration steps with the external device 202. For example, packets exchanged between the electronic device 201 and the external device 202 may include an identification packet, a configuration packet, or a FOD (foreign object detection) status packet. After the identification step is completed, the electronic device 201 and the external device 202 may start a power transmission step. In the power transmission step, the external device 202 may measure the power received from the electronic device 201 and transmit data about the measured received power to the electronic device 201, thereby adjusting the level of the transmitted power. The external device 202 may transmit a control error packet (CEP) or a FOD status packet to the electronic device 201. Based on receiving the CEP, the electronic device 201 may perform interruption of wireless power transmission or adjustment of the transmission power.

In operation 350, if the external device 202 does not support EPP charging, the electronic device 201 according to an embodiment may perform BPP charging of wirelessly transmitting power of up to about 5 W to the external device 202. BPP charging may be charging without performing negotiation, calibration, or renegotiation steps between the electronic device 201 and the external device 202.

In operation 360, the electronic device 201 according to an embodiment may determine whether a response signal is received from the external device 202 after outputting the second ping. If a response signal is received from the external device after outputting the second ping (e.g., YES in operation 360), the electronic device may reperform operation 310. If a response signal is not received from the external device 202 after outputting the second ping (e.g., NO in operation 360), the electronic device 201 may perform operation 380.

According to an embodiment, even if each of the electronic device 201 and the external device 202 supports MPP charging, if the magnets for aligning the electronic device 201 and the external device 202 are in a misalignment state, the external device 202 may not output a response signal to the second ping.

According to an embodiment, if the N value, indicating the number of times MPP charging has been attempted repeatedly, is less than a specified first threshold, and if a response to the second ping is received from the external device 202, the electronic device 201 may return to operation 310, thereby performing operation 310 again.

According to an embodiment, if an XID packet is not received from the external device 202 after outputting the second ping, the electronic device 201 may determine that the external device 202 does not exist within a specified distance from the electronic device 201 and then perform operation 380.

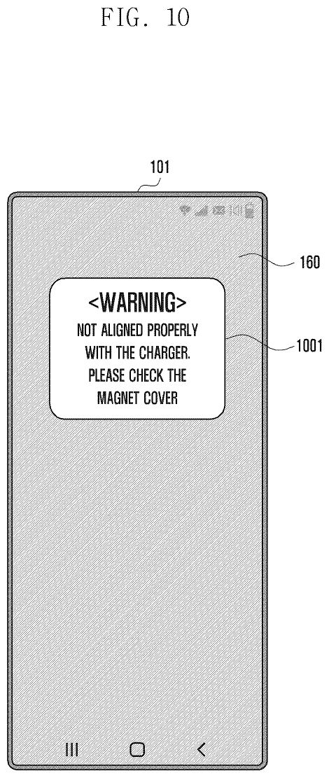

According to an embodiment, if a response signal is received from the external device 202 after outputting the second ping (e.g., YES in operation 360), the electronic device 201 may transmit, to the external device 202, a misalignment signal indicating misalignment of the external device 202. According to an embodiment, the electronic device 201 may transmit the misalignment signal through in-band communication (e.g., FSK (frequency shift keying) method or ASK (amplitude shift keying) method) or out-band communication (e.g., Bluetooth communication). The external device 202 may identify that the alignment of the electronic device 201 and the external device 202 using the magnets is not correct by receiving the misalignment signal from the electronic device 201. As will be described below with reference to FIG. 10, the external device 202 may output a specified notification, based on the misalignment signal received from the electronic device 201. For example, the specified notification may be configured such that the external device 202 displays a message (e.g., 1001 in FIG. 10) through a display module (the display module 160 in FIG. 10) of the external device 202, but the disclosure is not limited thereto.

In operation 370, the electronic device 201 according to an embodiment may perform MPP charging. According to an embodiment, the electronic device 201 may change the operating frequency from about 128 kHz to about 360 KHz and perform negotiation, calibration, or renegotiation steps for MPP charging.

According to an embodiment, if the N value, indicating the number of times MPP charging has been attempted repeatedly, is less than a specified first threshold, and if a response to the first ping is received from the external device 202, the electronic device 201 may perform first negotiation communication with the external device 202 for MPP charging (e.g., first wireless charging). When the first negotiation communication with the external device 202 is completed, the electronic device 201 may wirelessly transmit power of about 15 W or more.

In operation 380, if a response to the first ping is not received from the external device 202, and if a response to the second ping is received from the external device 202, the electronic device 201 according to an embodiment may switch to a standby state. The standby state may be a state in which the electronic device 201 outputs an analog ping to detect the external device 202.

According to an embodiment, the electronic device 201 may perform an operation of identifying whether a specific object (e.g., the power receiving device in FIG. 2) is located around the coil by outputting an analog ping before outputting a digital ping in operation 310. If the electronic device 201 detects a specific object by outputting the analog ping, the electronic device 201 may reperform operation 310.

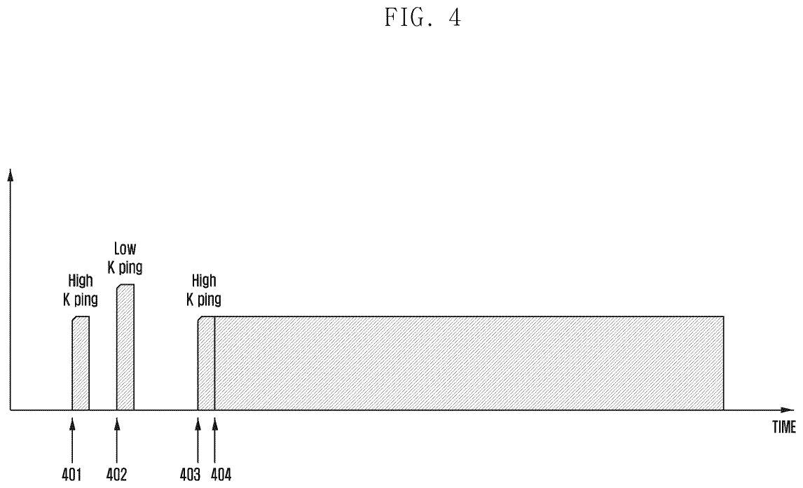

FIG. 4 is a diagram illustrating an example of a scenario in which a power supply device 201 performs MPP charging according to various embodiments. In FIG. 4, the horizontal axis may represent time, and the vertical axis may represent the intensity of power.

Hereinafter, an example scenario in which a power supply device 201 according to an embodiment performs MPP charging will be described with reference to FIG. 3 and FIG. 4.

At time point 401, an electronic device 201 (e.g., the power supply device in FIG. 2) according to an embodiment may output a digital ping to wake up an external device 202 (e.g., the power receiving device 202 in FIG. 2). The digital ping may include a first ping (e.g., high K ping) and a second ping (e.g., low K ping). The electronic device 201 may preferentially output the first ping among the first ping and the second ping, and the time point 401 indicates a state in which the electronic device outputs the first ping.

At time point 402, the electronic device 201 according to an embodiment may output a second ping if a response signal is not received from the external device for a specified time after outputting the first ping.

The operation of the electronic device 201 at time points 401 and 402 illustrated in FIG. 4 may be at least partially similar to or substantially identical to the operation 310 described with reference to FIG. 3.

At time point 403, the electronic device 201 according to an embodiment may output a first ping again if a response signal is not received from the external device 202 for a specified time after outputting the second ping.

At time point 404, the electronic device 201 according to an embodiment may receive a response signal of the external device 202 after outputting the first ping. The response signal may include an extended identification data (XID) packet indicating that MPP is supported. For example, if the XID as a response signal of the external device 202 to the digital ping is received, the electronic device 201 may determine that the external device 202 is a device that supports MPP charging.

The electronic device 201 according to an embodiment may perform first negotiation communication for MPP charging (e.g., first wireless charging) in response to receiving the response signal of the external device 202.

According to an embodiment, the electronic device 201 may perform MPP charging when the first negotiation communication is completed. For example, the electronic device 201 may perform communication of negotiation, calibration, and renegotiation for MPP charging with the external device 201 and perform MPP charging, based on the negotiation result. Here, the electronic device 201 performing MPP charging may indicate an operation in which the electronic device 201 wirelessly transmits power of about 15 W or more to the external device 201.

According to an embodiment, the operation in which the electronic device transmits power at time point 404 may be an operation subsequent to the operation in which the first ping (e.g., high K ping) is output at time point 403.

According to an embodiment, the negotiation, calibration, or renegotiation step for MPP charging may be performed after the time point 404.

The operation of the electronic device 201 at time point 404 illustrated in FIG. 4 may be at least partially similar to or substantially identical to the operation described with reference to FIG. 3.

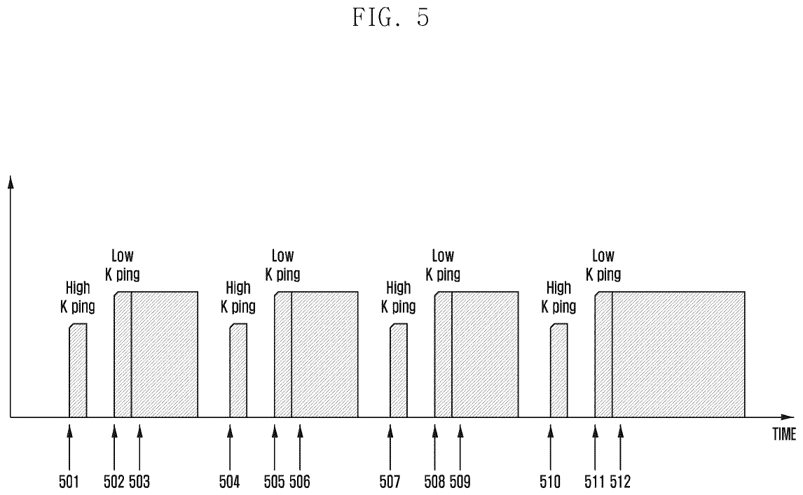

FIG. 5 is a diagram illustrating an example of a scenario in which a power supply device 201 performs BPP charging (or EPP charging) according to various embodiments. In FIG. 5, the horizontal axis may represent time, and the vertical axis may represent the intensity of power.

Hereinafter, an example scenario in which a power supply device 201 according to an embodiment performs BPP charging (or EPP charging) will be described with reference to FIG. 3 and FIG. 5.

At time points 501, 504, 507, and 510, the electronic device 201 (e.g., the power supply device 201 in FIG. 2) according to an embodiment may output a digital ping to wake up an external device 202 (e.g., the power receiving device 202 in FIG. 2). The digital ping may include a first ping and a second ping. The electronic device may preferentially output the first ping among the first ping and the second ping, and time points 501, 504, 507, and 510 represent a state in which the electronic device outputs the first ping.

At time points 502, 505, 508, and 511, the electronic device 201 according to an embodiment may output a second ping if a response signal is not received from the external device 202 for a specified time after outputting the first ping.

The operation of the electronic device 201 at time points 502, 505, 508, and illustrated in FIG. 5 may be at least partially similar to or substantially identical to the operation 360 described with reference to FIG. 3.

At time points 503, 506, 509, and 512, the electronic device 201 according to an embodiment may receive a response signal of the external device 202 after outputting the second ping. The response signal may include an extended identification data (XID) packet indicating that MPP is supported. For example, if the XID as a response signal of the external device 202 to the digital ping is received, the electronic device 201 may determine that the external device 202 is a device that supports MPP charging.

If a response signal to the second ping is received from the external device 202, the electronic device 201 according to an embodiment may return to the ping step for MPP charging and output the first ping and the second ping. For example, the electronic device 201, based on receiving the response signal to the second ping from the external device 202 at time point 503, may output the first ping again at time point 504 and, if a response signal to the first ping is not received from the external device 202, output the second ping at time point 505. For example, the electronic device 201 based on receiving a response signal to the second ping from the external device 202 at time point 506, may output the first ping again at time point 507 and, if a response signal to the first ping is not received from the external device 202, output the second ping at time point 508. For example, the electronic device 201, based on receiving a response signal to the second ping from the external device 202 at time point 509, may output the first ping again at time point 510 and, if a response signal to the first ping is not received from the external device 202, output the second ping at time point 511.

The electronic device 201 according to an embodiment may receive a response signal to the second ping, increase the N value indicating the number of ping outputs by 1, and output the first ping.

According to an embodiment, if a response signal to the second ping is received from the external device 202, the electronic device 201 may determine that the external device 202 is in a misaligned state and return to the ping step to output the first ping. The electronic device 201 according to an embodiment may be configured to not infinitely repeat the operation of returning to the ping step and outputting the first ping, based on the result of determining that the external device 202 is in a misaligned state, but may be configured to perform the operation of returning to the ping step only within a specified number of times. For example, the electronic device 201 may determine whether the N value, indicating the cumulative number of times the first ping and the second ping have been output, is greater than or equal to a threshold, as described in operation 330 in FIG. 3. Although the illustrated example shows that the electronic device 201 no longer outputs the first ping and the second ping for MPP charging at time point 512 at which the electronic device 201 receives the fourth response signal to the second ping from the external device 202, and performs EPP charging or BPP charging, the disclosure is not limited thereto.

At time point 512, if the N value, indicating the number of times MPP charging has been attempted repeatedly, is greater than or equal to a specified first threshold, the electronic device 201 according to an embodiment may perform EPP charging or BPP charging. The electronic device 201 according to an embodiment may determine whether the external device 202 supports EPP charging. If the external device 202 supports EPP charging, the electronic device 201 may perform EPP charging of wirelessly transmitting power of up to about 15 W to the external device 202. If the external device 202 does not support EPP charging, the electronic device according to an embodiment may perform BPP charging of wirelessly transmitting power of up to about 5 W to the external device 202. BPP charging may be charging performed without negotiation, calibration, or renegotiation steps between the electronic device 201 and the external device 202.

The operation of the electronic device 201 at time point 512 illustrated in FIG. 5 may be at least partially similar to or substantially identical to the operation described with reference to FIG. 3.

According to an embodiment, the operation of the electronic device 201 transmitting power according to EPP or BPP at time point 512 may be an operation subsequent to the operation of outputting the second ping (e.g., low K ping) at time point 511.

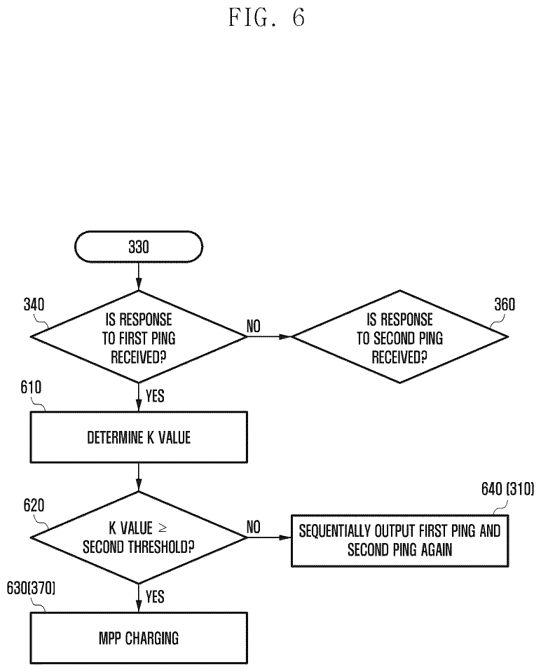

FIG. 6 is a flowchart illustrating an example operation in which a power supply device 201 determines whether to perform MPP charging, based on a K value indicating an alignment state of coils according to various embodiments.

At least some of the operations illustrated in FIG. 6 may be omitted. At least some of the operations mentioned with reference to other drawings in the disclosure may be further performed before or after at least some of the operations illustrated in FIG. 6.

According to an embodiment, at least some of the operations illustrated in FIG. 6 may be performed sequentially.

According to an embodiment, at least some of the operations illustrated in FIG. 6 may be performed in parallel (simultaneously).

According to an embodiment, at least some of the operations illustrated in FIG. 6 may be performed in different sequences.

Hereinafter, an operation of a power supply device 201 according to an embodiment to determine whether to perform MPP charging, based on a K value indicating an alignment state of coils, will be described with reference to FIG. 6.

Operation 610 illustrated in FIG. 6 may be performed after operations 330 and 340 described with reference to FIG. 3. For example, an electronic device 201 (e.g., the power supply device 201) according to the example embodiment in FIG. 6 may further perform operations 610 to 640 for determining whether to perform MPP charging, based on a K value indicating an alignment state of coils.

In operation 610, the electronic device 201 (e.g., the power supply device in FIG. 2) according to an embodiment, if a response signal is received from the external device 202 after outputting the first ping (e.g., YES in operation 340), may determine a K value indicating an alignment state of the electronic device 201 and the external device 202.

In various embodiments of the disclosure, the “K value” indicates a degree of coupling between a coil (e.g., a first coil) of the electronic device 201 and a coil (e.g., a second coil) of the external device 202, and for example, the K value may increase as the degree of coupling between the coil (e.g., the first coil) of the electronic device 201 and the coil (e.g., the second coil) of the external device 202 increases. A relatively large K value may indicate that the coil (e.g., the first coil) of the electronic device 201 and the coil (e.g., the second coil) of the external device 202 are aligned at an optimal position. A relatively small K value may indicate that the coil (e.g., the first coil) of the electronic device 201 and the coil (e.g., the second coil) of the external device 202 are misaligned from the optimal position.

The electronic device 201 according to an embodiment may determine the K value, based on an output voltage output from an inverter of the electronic device 201 and data received from the external device 202. For example, the electronic device may receive a specified packet from the external device 202, and the specified packet may include a rectified voltage of the external device 202. According to an embodiment, the specified packet may be included in a signal strength packet (SSP) signal. For example, the SSP signal may include a rectified voltage or current-related data. According to an embodiment, the electronic device 201 may calculate a gain in the digital ping step, based on the output voltage of the inverter and the rectified voltage of the external device 202, and determine a K value indicating the degree of coupling between the coil (e.g., the first coil) of the electronic device 201 and the coil (e.g., the second coil) of the external device 202, based on the calculated gain.

According to an embodiment, the electronic device 201 may transmit the determined K value to the external device 202. In this case, the external device 202, based on the K value received from the electronic device 201, may identify the K value indicating the degree of coupling between the coil (e.g., the first coil) of the electronic device 201 and the coil (e.g., the second coil) of the external device 202.

According to an embodiment, if a response signal is received from the external device 202 after outputting the first ping (e.g., YES in operation 340), the electronic device 201 may transmit a specified packet including the output voltage of the inverter to the external device 202. In this case, the external device 202 may calculate the K value independently of the electronic device 201.

In operation 620, the electronic device 201 according to an embodiment may determine whether the determined K value is greater than or equal to a specified second threshold. If the determined K value is greater than or equal to the specified second threshold (e.g., YES in operation 620), the electronic device 201 according to an embodiment may perform operation 630. If the determined K value is less than the specified second threshold (e.g., NO in operation 620), the electronic device 201 according to an embodiment may perform operation 640.

In operation 630, the electronic device 201 according to an embodiment may perform MPP charging if the K value is greater than or equal to a specified second threshold. The electronic device 201 according to an embodiment may change the operating frequency from about 128 kHz to about 360 kHz and perform negotiation, calibration, or renegotiation steps for MPP charging.

According to an embodiment, if the N value, indicating the number of times MPP charging has been repeatedly attempted, is less than a specified first threshold, if a response to the first ping is received from the external device 202, and if the K value, indicating the degree of coupling between the coil (e.g., the first coil) of the electronic device 201 and the coil (e.g., the second coil) of the external device 202, is greater than or equal to a second threshold, the electronic device 201 may perform first negotiation communication for MPP charging (e.g., first wireless charging) with the external device 202. If the first negotiation communication with the external device 202 is completed, the electronic device 201 may wirelessly transmit power of about 15 W or more.

Operation 630 may be at least partially similar to operation 370 described with reference to FIG. 3.

In operation 640, if the K value is less than the specified second threshold, the electronic device 201 according to an embodiment may sequentially output the first ping and the second ping again, as a step of re-outputting digital pings. For example, even if a response to the first ping is received from the external device 202, the electronic device 201 may determine the degree of coupling between the coil (e.g., the first coil) of the electronic device 201 and the coil (e.g., the second coil) of the external device 202 by determining the K value. If a response to the first ping is received from the external device 202, and if the K value is less than the specified second threshold, the electronic device 201 may consider that the alignment state between the electronic device 201 and the external device 202 does not satisfy an optimal condition, and thus the electronic device 201 may output a digital ping again. In addition, if a response to the first ping is received from the external device 202, and charging if the state in which and the K value is less than the specified second threshold is repeated a specified number of times (e.g., the N value in FIG. 3), the electronic device 201 may be configure to perform EPP charging or BPP charging.

Operation 640 may be at least partially similar to operation 310 described with reference to FIG. 3.

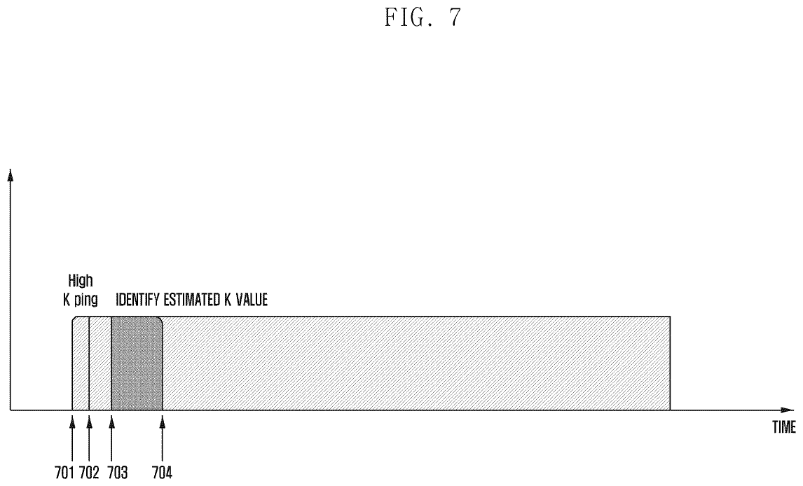

FIG. 7 is a diagram illustrating an example of a scenario in which a power supply device 201 performs MPP charging, based on a K value greater than or equal to a threshold, according to various embodiments. In FIG. 7, the horizontal axis may represent time, and the vertical axis may represent the intensity of power.

Hereinafter, an example scenario in which a power supply device 201 according to an embodiment performs MPP charging, based on a K value greater than or equal to a threshold, will be described with reference to FIGS. 6 and 7.

At time point 701, an electronic device 201 according to an embodiment may output a first ping as a digital ping. An electronic device 201 (e.g., the power supply device 201 in FIG. 2) according to an embodiment may output a digital ping to wake up an external device 202 (e.g., the power receiving device 202 in FIG. 2). The digital ping may include a first ping and a second ping. The electronic device 201 may preferentially output the first ping among the first ping and the second ping, and time point 701 represents a state in which the electronic device 201 outputs the first ping.

At time point 702, the electronic device 201 according to an embodiment may receive a response signal of the external device 202 after outputting the first ping. The response signal may include an extended identification data (XID) packet indicating that MPP is supported. For example, if the XID as a response signal of the external device 202 to the digital ping is received, the electronic device 201 may determine that the external device 202 is a device that supports MPP charging.

At time point 703, if a response signal is received from the external device 202, the electronic device 201 according to an embodiment may determine a K value indicating an alignment state of the electronic device 201 and the external device 202.

The electronic device 201 according to an embodiment may determine the K value, based on an output voltage output from an inverter of the electronic device 201 and data received from the external device 202. For example, the electronic device may receive a specified packet from the external device 202, and the specified packet may include a rectified voltage of the external device 202. The electronic device 201 may calculate a gain in the digital ping step, based on the output voltage of the inverter and the rectified voltage of the external device 202, and determine a K value indicating the degree of coupling between a coil (e.g., a first coil) of the electronic device 201 and a coil (e.g., a second coil) of the external device 202, based on the calculated gain.

According to an embodiment, the electronic device 201 may transmit the determined K value to the external device 202. In this case, the external device 202 may identify the K value indicating the degree of coupling between the coil (e.g., the first coil) of the electronic device 201 and the coil (e.g., the second coil) of the external device 202, based on the K value received from the electronic device 201.

In an embodiment, if a response signal is received from the external device after outputting the first ping (e.g., YES in operation 340), the electronic device may transmit a specified packet including the output voltage of the inverter to the external device 202. In this case, the external device 202 may calculate the K value independently of the electronic device 201.

At time point 704, the electronic device 201 according to an embodiment may perform MPP charging if the determined K value is greater than or equal to a specified second threshold. The electronic device 201 according to an embodiment may change the operating frequency from about 128 kHz to about 360 kHz and perform negotiation, calibration, or renegotiation steps for MPP charging.

According to an embodiment, the electronic device 201 may perform first negotiation communication for MPP charging (e.g., first wireless charging) with the external device 202. The electronic device 201 may wirelessly transmit power of about 15 W or more if the first negotiation communication with the external device is completed.

The operation of the electronic device 201 according to an embodiment at time point 704 may be at least partially similar to the operation 630 described with reference to FIG. 6.

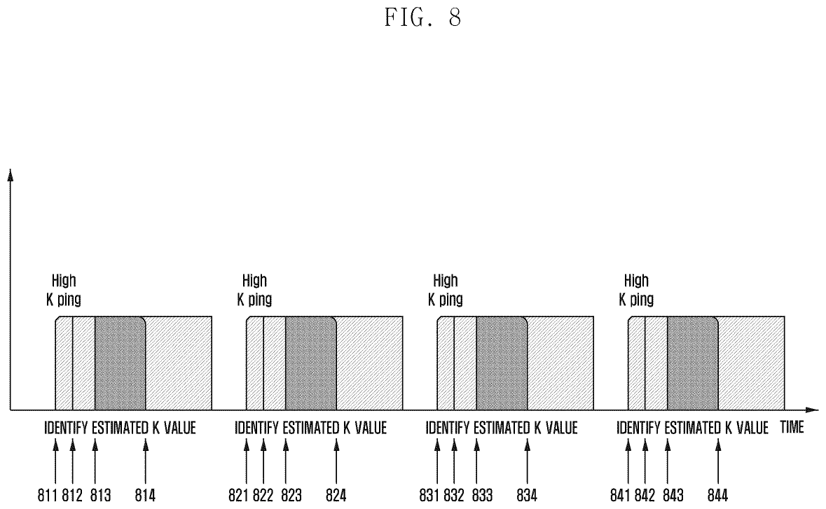

FIG. 8 is a diagram illustrating an example of a scenario in which a power supply device 201 performs BPP charging (or EPP charging), based on a K value less than a threshold, according to various embodiments. In FIG. 8, the horizontal axis may represent time, and the vertical axis may represent the intensity of the power.

Hereinafter, an example scenario in which the power supply device 201 according to an embodiment performs BPP charging (or EPP charging), based on a K value less than a threshold, will be described with reference to FIG. 6 and FIG. 8.

At time points 811, 821, 831, and 841, the electronic device 201 according to an embodiment may output a first ping as a digital ping. An electronic device 201 (e.g., the power supply device 201 in FIG. 2) according to an embodiment may output a digital ping to wake up an external device 202 (e.g., the power receiving device 202 in FIG. 2). The electronic device 201 may start in a BPP mode of about 128 kHz when starting a wireless charging mode. The digital ping may include a first ping and a second ping. The electronic device 201 may preferentially output the first ping among the first ping and the second ping, and time points 811, 821, 831, and 841 represent a state in which the electronic device 201 outputs the first ping.

At time points 812, 822, 832, and 842, the electronic device 201 according to an embodiment may receive a response signal of the external device 202 after outputting a first ping. The response signal may include an extended identification data (XID) packet indicating that MPP is supported. For example, if the XID as a response signal of the external device 202 to the digital ping is received, the electronic device 201 may determine that the external device 202 is a device that supports MPP charging.

At time points 813, 823, 833, and 843, the electronic device 201 according to an embodiment may determine a K value indicating an alignment state of the electronic device 201 and the external device 202. The electronic device 201 according to an embodiment may determine the K value, based on an output voltage output from an inverter of the electronic device 201 and data received from the external device 202. For example, the electronic device 201 may receive a specified packet from the external device 202, and the specified packet may include a rectified voltage of the external device 202. The electronic device 201 may calculate a gain in the digital ping step, based on the output voltage of the inverter and the rectified voltage of the external device 202, and determine a K value indicating the degree of coupling between a coil (e.g., a first coil) of the electronic device 201 and a coil (e.g., a second coil) of the external device 202, based on the calculated gain.

At time points 814, 824, and 834, the electronic device 201 according to an embodiment may transmit the determined K value to the external device 202. In this case, the external device 202 may identify the K value indicating the degree of coupling between the coil (e.g., the first coil) of the electronic device 201 and the coil (e.g., the second coil) of the external device 202, based on the K value received from the electronic device 201.

According to an embodiment, the external device 202 may calculate the K value independently of the electronic device 201. For example, if a response signal from the external device 202 after outputting the first ping (e.g., YES in operation 340 in FIG. 3), the electronic device 201 may transmit a specified packet including the output voltage of the inverter to the external device 202. The external device 202 may calculate the K value independently of the electronic device 201, based on analyzing the output voltage of the inverter received from the electronic device 201.

The electronic device 201 according to an embodiment may output a digital ping again if the determined K value is less than a specified second threshold. If the K value is less than the specified second threshold, the electronic device 201 according to an embodiment may determine that the external device 202 is in a misaligned state and return to the ping step to output the first ping. For example, the electronic device 201, based on identifying that the K value is less than the specified second threshold at time point 813, may transmit the K value to the external device 202 at time point and output the first ping again at time point 821. For example, the electronic device 201, based on identifying that the K value is less than the specified second threshold at time point 823, may transmit the K value to the external device 202 at time point 824 and output the first ping again at time point 831. For example, the electronic device 201, based on identifying that the K value is less than the specified second threshold at time point 833, may transmit the K value to the external device at time point 834 and output the first ping again at time point 841.

At time points 821, 831, and 841, the electronic device 201 according to an embodiment may output the digital ping again if the K value determined at time points 813, 823, or 833 is less than the specified second threshold. For example, the electronic device 201 may sequentially output the first ping and the second ping again. For example, even if a response to the first ping is received from the external device (e.g., at time points 812, 822, and 833), the electronic device 201 may determine the K value, instead of immediately starting MPP charging, to identify the degree of coupling between the coil (e.g., the first coil) of the electronic device 201 and the coil (e.g., the second coil) of the external device 202. If a response to the first ping is received from the external device 202, and if the K value is less than the specified second threshold, the electronic device 201 may consider that the alignment state between the electronic device 201 and the external device 202 does not satisfy an optimal condition and output digital pings again, such as at time points 821, 831, and 841.

The electronic device 201 according to an embodiment may be configured to not infinitely repeat the operation of returning to the ping step and outputting the first ping, based on identifying that the K value is less than the specified second threshold, but may be configured to perform the operation of returning to the ping step only within a specified number of times. Although the illustrated example shows that the electronic device 201 no longer outputs the first ping and the second ping for MPP charging after time point 843 at which the electronic device 201 performs the fourth identification of the K value being less than the specified second threshold, and performs EPP charging or BPP charging at time point 844, the disclosure is not limited thereto.

At time 844, the electronic device 201 according to an embodiment may perform EPP charging or BPP charging after receiving the response to the first ping from the external device 202. The electronic device 201 according to an embodiment may determine whether the external device 202 supports EPP charging. If the external device 202 supports EPP charging, the electronic device 201 may perform EPP charging of wirelessly transmitting power of up to about 15 W to the external device 202. If the external device 202 does not support EPP charging, the electronic device according to an embodiment may perform BPP charging of wirelessly transmitting power of up to about 5 W to the external device 202. BPP charging may be charging without performing negotiation, calibration, or renegotiation steps between the electronic device 201 and the external device 202.

The operation of the electronic device 201 according to an embodiment at time point 844 may be at least partially similar to the operation 350 described with reference to FIG. 3.

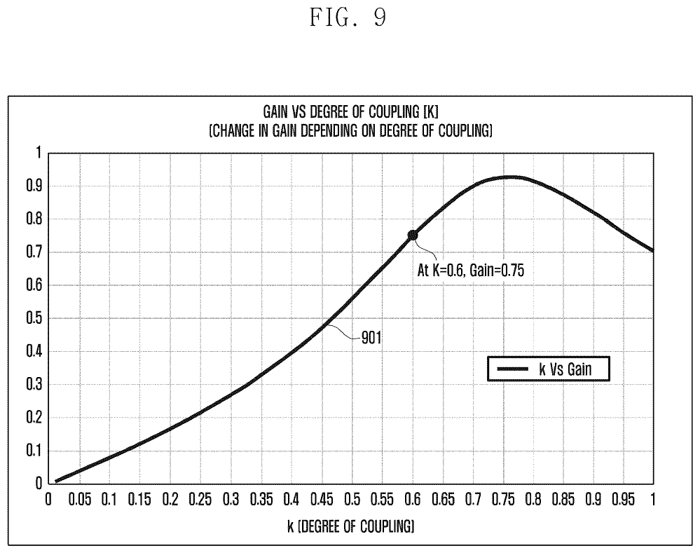

FIG. 9 is a graph illustrating an example of a correlation between a gain of a wireless charging system and a K value according to various embodiments.

Referring to FIG. 9, an electronic device 201 (e.g., the power supply device in FIG. 2) according to an embodiment may determine a K value, based on an output voltage output from an inverter of the electronic device 201 and data received from an external device 202 (e.g., the power receiving device 202 in FIG. 2). For example, the electronic device 201 may receive a specified packet from the external device 202, and the specified packet may include a rectified voltage of the external device 202. The electronic device 201 may calculate a gain in the digital ping step, based on the output voltage of the inverter and the rectified voltage of the external device 202, and determine a K value indicating the degree of coupling between a coil (e.g., a first coil) of the electronic device 201 and a coil (e.g., a second coil) of the external device 202, based on the calculated gain.

According to an embodiment, if a response signal is received from the external device 202 after outputting the first ping (e.g., YES in operation 340 in FIG. 3), the electronic device 201 may transmit a specified packet including the output voltage of the inverter to the external device 202. In this case, the external device 202 may calculate the K value independently of the electronic device 201.

The K value, which indicates the degree of coupling between a coil (e.g., a first coil) of the electronic device 201 and a coil (e.g., a second coil) of the external device 202, and a gain in the digital ping step may have a correlation such as the curve illustrated in FIG. 9. For example, in FIG. 9, the horizontal axis may indicate the K value, and the vertical axis may indicate the gain in the digital ping step. As illustrated in FIG. 9, as the K value increases, the gain in the digital ping step tends to increase, and therefore, the electronic device 201 or the external device 202 may estimate the gain from the identified K value. In addition, the electronic device 201 or the external device 202 may determine whether the coil (e.g., the first coil) of the electronic device 201 and the coil (e.g., the second coil) of the external device 202 are aligned at the optimal position from the identified K value.

According to an embodiment, if the K value is about 0.6 or higher (e.g., about 0.6 to about 0.85), the electronic device 201 and/or the external device 202 may determine that the coil (e.g., the first coil) of the electronic device 201 and the coil (e.g., the second coil) of the external device 202 are aligned at the optimal position. For example, according to the illustrated graph, when the K value is about 0.6, the gain may be about 0.75, and the electronic device 201 and/or the external device 202, if the K value is about 0.6 or more and the gain is about 0.75 or more, may determine that the coil (e.g., the first coil) of the electronic device 201 and the coil (e.g., the second coil) of the external device 202 are aligned at an optimal position.

FIG. 10 is a diagram illustrating an example of a notification output from a power receiving device 202 according to various embodiments.

Referring to FIG. 10, if a response signal is received from the external device after outputting the second ping (e.g., YES in operation 360 in FIG. 3), the electronic device 201 may transmit, to the external device 202, a misalignment signal indicating misalignment of the external device 202. The external device 202 may identify that the alignment of the electronic device 201 and the external device 202 using the magnets is not correct by receiving the misalignment signal from the electronic device 201.

According to an embodiment, the external device 202 may output a specified notification 1001, based on the misalignment signal received from the electronic device 201. For example, the specified notification may be configured in the form in which the external device 202 displays a message through a display module of the external device 202. In response to the misalignment signal received from the electronic device 201, the external device 202 may display a message 1001 informing the user of the misalignment state of the electronic device 201 and the external device using the magnets, such as “Not aligned properly with the charger (e.g., travel adapter). Please check the magnet cover.”

According to various embodiments, the external device 202 may provide a notification in the form of sound or voice to inform of the misalignment state of the electronic device 201 and the external device 202 due to an error in the magnet cover.

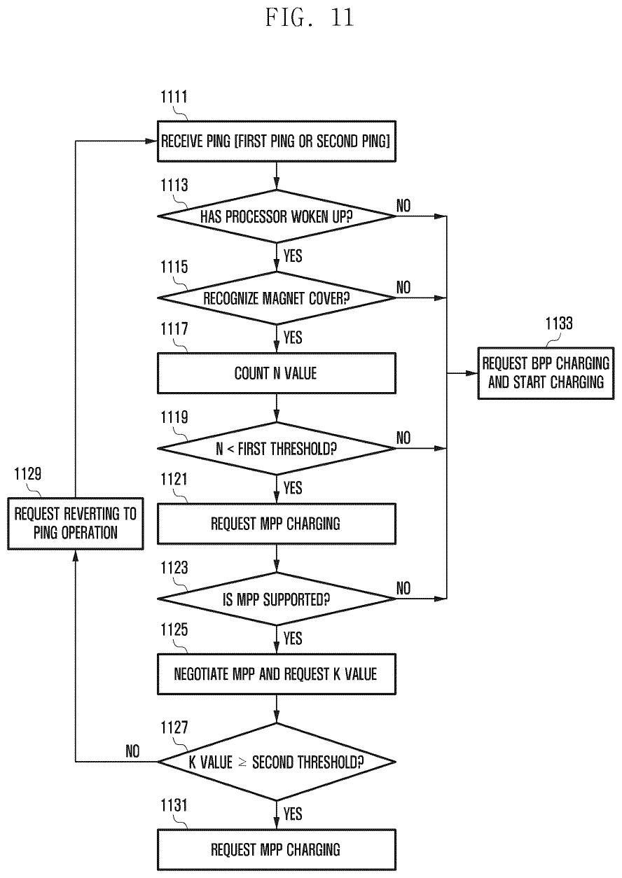

FIG. 11 is a flowchart illustrating an example operation of a power receiving device 202 according to various embodiments.

The operations illustrated in FIG. 11 may be performed by instructions stored in a memory (e.g., the memory 288 in FIG. 2). For example, the instructions, when executed by a processor (e.g., processor 299 in FIG. 2), may cause an electronic device (e.g., the power receiving device 202 in FIG. 2) to perform the operations illustrated in FIG. 11.

At least some of the operations illustrated in FIG. 11 may be omitted. At least some of the operations mentioned with reference to other drawings in the disclosure may be further performed before or after at least some of the operations illustrated in FIG. 11.

According to an embodiment, at least some of the operations illustrated in FIG. 11 may be performed sequentially.

According to an embodiment, at least some of the operations illustrated in FIG. 11 may be performed in parallel (simultaneously).

According to an embodiment, at least some of the operations illustrated in FIG. 11 may be performed in different sequences.

Hereinafter, the operation of the power receiving device 202 according to an embodiment will be described with reference to FIG. 11.

In operation 1111, an electronic device 202 (e.g., the power receiving device 202 in FIG. 2) according to an embodiment may receive a ping from an external device (e.g., the power supply device 201 in FIG. 2) when starting wireless charging. The ping received from the external device 201 may be, for example, a first ping or a second ping as digital pings.

In operation 1113, upon receiving the digital ping from the external device 201, the electronic device 202 according to an embodiment may identify whether the processor 299 is in an awake state. For example, if the power of the electronic device is off, the processor 299 may not be in an awake state. If the electronic device receives a digital ping from the external device 201, a wireless charging circuit (e.g., the wireless charging circuit 220 in FIG. 2) may wake up, and the woken-up wireless charging circuit may identify whether the processor 299 is in an awake state.

If the processor 299 is in an awake state (e.g., YES in operation 1113), the electronic device 202 according to an embodiment may perform operation 1115. If the processor 299 in an awake state (e.g., NO in operation 1113), the electronic device according to an embodiment may perform operation 1133.

In operation 1115, the electronic device 202 according to an embodiment may determine whether a cover accessory including a magnet is coupled to the electronic device 202. The cover accessory may include at least one magnet facing the back side of the electronic device 202 considering that the electronic device 202 supports MPP charging. If the magnet of the cover accessory is not a genuine product mass-produced by the manufacturer of the electronic device 202, there may be a design error in which the coil of the electronic device 202 is not precisely aligned with the coil of the external device 201. The design error of the magnet of the cover accessory may cause a charging error that interrupts MPP charging between the electronic device 202 and the external device 201.

According to an embodiment, if the magnet cover of the cover accessory is recognized (e.g., YES in operation 1115), the electronic device 202 may perform operation 1117. According to an embodiment, if the magnet cover of the cover accessory is not recognized (e.g., NO in operation 1115), the electronic device 202 may perform operation 1133.

In operation 1117, the electronic device 202 according to an embodiment may count an N value, which is the cumulative number of times the digital ping of the external device 201 has been received. The electronic device 202 may determine the N value by directly counting the number of times the digital ping has been received. In an embodiment, the electronic device 202 may recognize the number of times the external device 201 has accumulated and output the digital pings by receiving the N value from the external device 201.

In operation 1119, the electronic device 202 according to an embodiment may determine whether the N value is less than a specified first threshold. If the N value is less than the specified first threshold (e.g., YES in operation 1119), the electronic device 202 may perform operation 1121. If the N value is greater than or equal to the specified first threshold (e.g., NO in operation 1119), the electronic device may perform operation 1133.

In operation 1121, if the N value is less than the specified first threshold, the electronic device 202 according to an embodiment may transmit a signal requesting MPP charging to the external device 201. For example, the electronic device 202 may transmit an extended identification data (XID) packet indicating that MPP is supported, as a response signal to the digital ping of the external device 201.

In operation 1123, the electronic device 202 according to an embodiment may identify whether the external device 201 supports MPP charging. If the external device 201 supports MPP charging (e.g., YES in operation 1123), the electronic device 202 may perform operation 1125. If the external device 201 does not support MPP charging (e.g., NO in operation 1123), the electronic device 202 may perform operation 1133.

In operation 1125, if the external device 201 supports MPP charging, the electronic device 202 according to an embodiment may perform first negotiation communication with the external device 201 for MPP charging (e.g., first wireless charging) and request a K value from the external device 201. The electronic device may identify the K value by receiving the K value determined by the external device 201. In an embodiment, the electronic device 202 may calculate the K value independently of the external device 201. In this case, the electronic device 202 may request an output voltage of the inverter from the external device 201 and calculate a gain in the digital ping step using the output voltage of the inverter and the rectified voltage received by the electronic device 202. The electronic device 202 may calculate the K value, based on the calculated gain.

In operation 1127, the electronic device 202 according to an embodiment may identify whether the K value is greater than or equal to a specified second threshold. If the K value is greater than or equal to the specified second threshold (e.g., YES in operation 1127), the electronic device 202 may perform operation 1131. If the K value is less than the specified second threshold (e.g., NO in operation 1127), the electronic device 202 may perform operation 1129.

In operation 1129, the electronic device 202 according to an embodiment may request the external device 201 to revert to the ping operation. For example, the electronic device 202 may transmit, to the external device 201, an error signal requesting the external device 201 to transmit the digital ping again. According to an embodiment, the external device 201 may reperform operation 1111 as a ping step in response to a request (e.g., the error signal) from the electronic device 202.

In operation 1131, the electronic device 202 according to an embodiment may request MPP charging from the external device 201. In response to the request of the electronic device 202, the external device 201 may change the operating frequency from about 128 kHz to about 360 kHz and perform negotiation, calibration, or renegotiation steps for MPP charging.

In operation 1133, the electronic device 202 according to an embodiment may request BPP charging from the external device 201 and start BPP charging. For example, the electronic device 202 may request BPP charging from the external device 201 if the processor 299 in an awake state. For example, the electronic device may request BPP charging from the external device 201 if the magnet cover of the cover accessory is not recognized. For example, the electronic device 202 may request BPP charging from the external device 201 if the N value, indicating the cumulative number of times the digital ping has been received, is greater than or equal to a specified first threshold. For example, the electronic device 202 may request BPP charging or EPP charging from the external device 201 if the external device 201 does not support MPP.

According to an embodiment, if the electronic device 202 is powered off, the processor 299 may be in an inactive state. For example, if the electronic device 202 is placed on a wireless charging pad (e.g., the external device 201) while the electronic device 202 is powered off, the processor 299 of the electronic device 202 may be in an inactive state. In this case, the electronic device 202 may perform BPP charging, based on a control circuit (e.g., the control circuit 270 in FIG. 2) of a wireless charging circuit (e.g., the wireless charging circuit 220 in FIG. 2) being activated and the control of the activated control circuit (e.g., the control circuit 270 in FIG. 2). Since BPP charging is performed without negotiation, calibration, or renegotiation steps between the electronic device 202 and the external device 201, it may be performed based on the control of the control circuit (e.g., the control circuit 270 in FIG. 2) even while the processor 299 is in an inactive state.

According to an embodiment, if the power of the electronic device 202 is turned off, the processor 299 may be in an inactive state. The electronic device 202 may activate the control circuit (e.g., the control circuit 270 in FIG. 2) of the wireless charging circuit (e.g., the wireless charging circuit 220 in FIG. 2) when wireless power is supplied from the external device 201, and may perform a BPP or EPP charging operation.

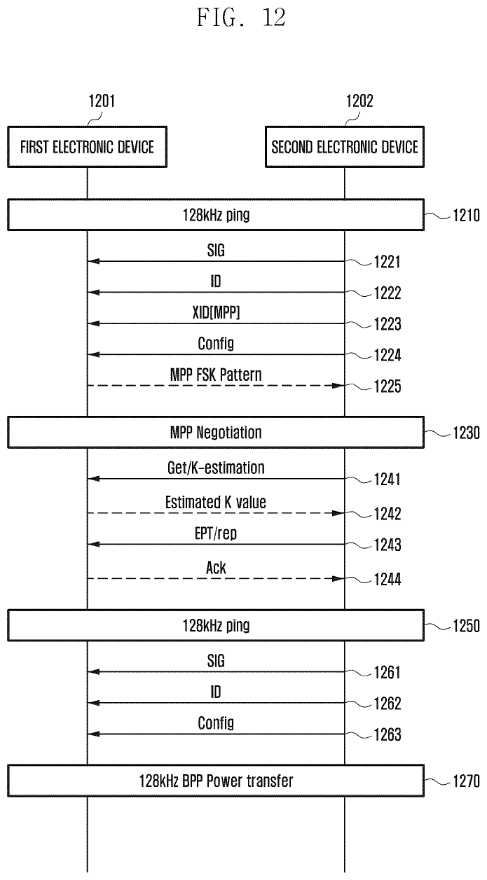

FIG. 12 is a signal flow diagram illustrating an example operation of a wireless charging system according to various embodiments.

Referring to FIG. 12, a wireless charging system according to an embodiment may include a first electronic device 1201 (e.g., the electronic device 102 in FIG. 1) and a second electronic device 1202 (e.g., the electronic device 101 in FIG. 1). For example, the first electronic device 1201 may be a power supply device (e.g., the power supply device 201 in FIG. 2) and the second electronic device 1202 may be a power receiving device (e.g., the power receiving device 202 in FIG. 2). The first electronic device 1201 and the second electronic device 1202 of the wireless charging system according to an embodiment may support high-speed wireless charging of about 15 W or more using a magnet by supporting MPP.

In operation 1210, the first electronic device 1201 may configure the operating frequency to about 128 kHz. The first electronic device 1201 may output a digital ping to wake up the second electronic device 1202. For example, the first electronic device 1201 may output a digital ping having a frequency of about 128 kHz. The digital ping may include a first ping and a second ping. The first electronic device may sequentially output the first ping and the second ping. The output power of the first ping may be lower than the output power of the second ping. The first electronic device 1201 may adjust the output power by adjusting the duty and voltage of the digital ping.

In operation 1221, the first electronic device 1201 may receive a signal strength packet (SSP) signal as a response to the first ping signal from the second electronic device 1202.

In operation 1222, the first electronic device 1201 may receive an identification (ID) signal including identification information from the second electronic device 1202. The identification information may include version information, a manufacturing code, or a device identifier.

In operation 1223, the first electronic device 1201 may receive an extended identification data (XID) packet signal from the second electronic device 1202 if the second electronic device 1202 is a device capable of supporting MPP. According to an embodiment, based on receiving the XID signal, the first electronic device 1201 may determine that the second electronic device 1202 is a device that supports MPP charging.

In operation 1224, the first electronic device 1201 may receive a configuration signal including configuration information related to wireless charging from the second electronic device 1202. The configuration information may include a wireless charging frequency, a maximum receivable power, or a power that the second electronic device 1202 requests from the first electronic device 1201 for battery charging.

In operation 1225, the first electronic device 1201 may output an MPP pattern signal for MPP charging in response to the XID signal received from the second electronic device 1202. For example, the first electronic device 1201 may transmit an MPP pattern signal for MPP charging to the second electronic device 1202 in a frequency shift keying (FSK) manner of modulating the frequency of a power signal. For example, the first electronic device 1201 may transmit an MPP pattern signal for MPP charging to the second electronic device 1202 in an amplitude shift keying (ASK) manner of modulating the amplitude of a power signal.

In operation 1230, the first electronic device 1201 may perform MPP negotiation for MPP charging with the second electronic device 1202. The MPP negotiation between the first electronic device 1201 and the second electronic device may include negotiation, calibration, or renegotiation steps.

In operation 1241, the first electronic device 1201 may receive, from the second electronic device 1202, data related to a K value indicating the degree of coupling between the coil of the first electronic device 1201 and the coil of the second electronic device 1202. For example, the first electronic device 1201 may receive rectified voltage or current-related data from the second electronic device 1202.

In operation 1242, the first electronic device 1201 may determine a K value indicating the degree of coupling between the coil of the first electronic device 1201 and the coil of the second electronic device 1202, based on the rectified voltage or current-related data received from the second electronic device 1202. According to an embodiment, the first electronic device 1201 may transmit the determined K value to the second electronic device 1202. In this case, the second electronic device 1202 may identify the degree of coupling between the coil of the first electronic device and the coil of the second electronic device 1202 by receiving the K value from the first electronic device 1201. According to various embodiments, the second electronic device 1202 may calculate the K value independently of the first electronic device 1201. For example, the first electronic device 1201 may transmit a specified packet including the output voltage of the inverter to the second electronic device 1202, and the second electronic device 1202 may calculate the K value independently of the first electronic device 1201 by analyzing the output voltage of the inverter.

In operation 1243, the first electronic device 1201 may receive at least one piece of charging-related data from the second electronic device 1202. At least one piece of charging-related data may include a control error packet (CEP), a received power packet (RPP), and/or an end of power transfer (EPT). According to an embodiment, the second electronic device 1202 may transmit a packet for reperforming the ping operation.

In operation 1244, if at least one piece of charging-related data is received from the second electronic device 1202, the first electronic device 1201 may transmit a response signal to the second electronic device.

In operation 1250, if the K value is less than the specified second threshold, as described with reference to operation 640 in FIG. 6, the first electronic device 1201 may sequentially output the first ping and the second ping again as a step of outputting the digital pings again. For example, operation 1250 may be substantially the same as operation 1210.

In operation 1261, the first electronic device 1201 may receive a signal strength packet (SSP) signal as a response to the first ping signal from the second electronic device 1202. Operation 1261 may be substantially the same as operation 1221.

In operation 1262, the first electronic device 1201 may receive an identification (ID) signal including identification information from the second electronic device 1202. The identification information may include version information, a manufacturing code, or a device identifier. Operation 1262 may be substantially the same as operation 1222.

In operation 1263, the first electronic device 1201 may receive a configuration signal including configuration information related to wireless charging from the second electronic device 1202. The configuration information may include a wireless charging frequency, a maximum receivable power, or a power that the second electronic device 1202 requests from the first electronic device 1201 for battery charging. Operation 1263 may be substantially the same as operation 1224.

In operation 1270, the first electronic device 1201 may perform EPP or BPP charging with respect to the second electronic device 1202. The first electronic device according to an embodiment may identify whether the second electronic device supports EPP charging. If the second electronic device 1202 supports EPP charging, the first electronic device 1201 may perform EPP charging of wirelessly transmitting power of up to about 15 W to the second electronic device 1202. If the second electronic device 1202 does not support EPP charging, the first electronic device 1201 according to an embodiment may perform BPP charging of wirelessly transmitting power of up to about 5 W to the second electronic device 1202.

An electronic device according to an example embodiment of the present disclosure may include: a coil, a transmitting integrated circuit (IC) configured to wirelessly transmit power to an external device through the coil, and a controller, comprising circuitry, wherein the controller may be configured to: output a first ping and/or a second ping through the coil, count an N value indicating a cumulative number of times the first ping and/or the second ping has been output, based on the N value being less than a specified first threshold and based on a response to the first ping being received from the external device, perform first negotiation communication with the external device for first wireless charging, the first wireless charging being performed based on an alignment state between the electronic device and the external device using a magnet, based on the N value being less than the first threshold and based on a response to the second ping being received from the external device, output the first ping and/or the second ping again, and, based on the N value being greater than or equal to the first threshold, perform second negotiation communication with the external device for second wireless charging independent of recognizing the magnet.

The controller may be configured to switch, based on the N value being less than the specified first threshold and based on a response to the first ping and a response to the second ping not being received from the external device, to a standby state for detecting an approach of the external device.

The magnet may include a first magnet of the electronic device or a second magnet included in an accessory coupled to the electronic device.

The controller may be configured to perform, based on a request signal for third wireless charging being received from the external device while performing the second negotiation communication with the external device for the second wireless charging, third communication with the external device for the third wireless charging, wherein the third wireless charging is low-speed wireless charging based on one-way communication in which data is transmitted from the external device to the electronic device, and a first power output by the electronic device according to the third wireless charging may be lower than a second power output by the electronic device according to the second wireless charging.

The controller may be configured to identify, based on the N value being less than the specified first threshold and based on a response to the first ping being received from the external device, a rectified voltage of the external device, determine a K value indicating an alignment state between the coil and a second coil of the external device, based on the rectified voltage, based on the determined K value being greater than or equal to a specified second threshold, perform the first negotiation communication with the external device, and, based on the determined K value being less than the second threshold, output the first ping and the second ping again.

The controller may be configured to cause the electronic device to transmit, based on the N value being less than the first threshold and based on a response to the second ping being received from the external device, a misalignment signal indicating misalignment between the electronic device and the external device to the external device.

An output power of the first ping may be lower than an output power of the second ping.

An electronic device according to an example embodiment of the present disclosure may include: a coil, a wireless charging circuit configured to wirelessly receive power from an external device through the coil, at least one processor, comprising processing circuitry, and a memory configured to store instructions, wherein at least one processor, individually and/or collectively, may be configured to execute the instructions and to cause the electronic device to: receive a ping of the external device through the coil, upon receiving the ping, identify whether at least one processor is in an awake state, based on at least one processor being in an awake state, determine whether a cover accessory including a magnet is coupled to the electronic device, based on the cover accessory being coupled to the electronic device, count an N value indicating a cumulative number of times the ping has been received, based on the N value being less than a specified first threshold, perform first negotiation communication with the external device for first wireless charging, the first wireless charging being performed based on an alignment state of the electronic device and the external device using a magnet, and, based on the N value being greater than or equal to the first threshold, perform second negotiation communication with the external device for second wireless charging independent of recognizing the magnet.

At least one processor, individually and/or collectively, may be configured to cause the electronic device to: perform third communication with the external device for third wireless charging based on at least one processor not being in the awake state, wherein the third wireless charging is low-speed wireless charging based on one-way communication in which data is transmitted from the external device to the electronic device, and a first power output by the electronic device according to the third wireless charging may be lower than a second power output by the electronic device according to the second wireless charging.

At least one processor, individually and/or collectively, may be configured to cause the electronic device to: identify a gain value indicating a ratio of a rectified voltage of the electronic device to an output voltage of the external device while performing the first negotiation communication with the external device, based on the identified gain value, determine a K value indicating an alignment state of the coil and a second coil of the external device, based on the determined K value being greater than or equal to a specified second threshold, perform the first negotiation communication with the external device, and, based on the determined K value being less than the second threshold, switch to a standby state for receiving the ping.

At least one processor, individually and/or collectively, may be configured to cause the electronic device to: receive, from the external device, a misalignment signal indicating misalignment between the electronic device and the external device while performing the first negotiation communication with the external device, and, in response to the misalignment signal, output a notification indicating misalignment between the electronic device and the external device.

The ping received from the external device may include a first ping and a second ping, and an output power of the first ping may be lower than an output power of the second ping, and the misalignment signal may be a signal received from the external device when the electronic device performs the first negotiation communication in response to the second ping of the external device.

A method of driving an electronic device configured to wirelessly transmit power to an external device according to an example embodiment of the present disclosure may include: outputting a first ping and/or a second ping sequentially through a coil, counting an N value indicating a cumulative number of times the first ping and/or the second ping has been output, based on the N value being less than a specified first threshold and based on a response to the first ping being received from the external device, performing first negotiation communication with the external device for first wireless charging, the first wireless charging being performed based on an alignment state between the electronic device and the external device using a magnet, based on the N value being less than the first threshold and based on a response to the second ping being received from the external device, outputting the first ping and/or the second ping again, and, based on the N value being greater than or equal to the first threshold, performing second negotiation communication with the external device for second wireless charging independent of recognizing the magnet.

The method may further include: performing third communication with the external device for third wireless charging based on a request signal for the third wireless charging being received from the external device while performing the second negotiation communication with the external device for the second wireless charging, wherein the third wireless charging may be low-speed wireless charging based on one-way communication in which data is transmitted from the external device to the electronic device, and a first power output by the electronic device according to the third wireless charging is lower than a second power output by the electronic device according to the second wireless charging.

The method may further include: identifying, based on the N value being less than a specified first threshold and based on a response to the first ping being received from the external device, a rectified voltage of the external device, determining a K value indicating an alignment state between the coil and a second coil of the external device, based on the rectified voltage, based on the determined K value being greater than or equal to a specified second threshold, performing the first negotiation communication with the external device, and, based on the determined K value being less than the second threshold, outputting the first ping and the second ping again.

The method may further include, based on the N value being less than the first threshold and based on a response to the second ping being received from the external device, transmitting a misalignment signal indicating misalignment between the electronic device and the external device to the external device.

An output power of the first ping may be lower than an output power of the second ping.

A method of driving an electronic device configured to wirelessly receive power from an external device according to an example embodiment of the present disclosure may include: receiving a ping of the external device through a coil, upon receiving the ping, identifying whether at least one processor is in an awake state, based on at least one processor being in an awake state, determining whether a cover accessory including a magnet is coupled to the electronic device, based on the cover accessory being coupled to the electronic device, counting an N value indicating a cumulative number of times the ping has been received, based on the N value being less than a first threshold, performing first negotiation communication with the external device for first wireless charging, the first wireless charging being performed based on an alignment state of the electronic device and the external device using a magnet, and, based on the N value being greater than or equal to the first threshold, performing second negotiation communication with the external device for second wireless charging independent of recognizing the magnet.

The method may further include: performing third communication with the external device for third wireless charging based on at least one processor not being in the awake state, wherein the third wireless charging may be low-speed wireless charging based on one-way communication in which data is transmitted from the external device to the electronic device, and a first power output by the electronic device according to the third wireless charging may be lower than a second power output by the electronic device according to the second wireless charging.

The method may further include: identifying a gain value indicating a ratio of a rectified voltage of the electronic device to an output voltage of the external device while performing the first negotiation communication with the external device, based on the identified gain value, determining a K value indicating an alignment state of the coil and a second coil of the external device, based on the determined K value being greater than or equal to a specified second threshold, performing the first negotiation communication with the external device, and, based on the determined K value being less than the second threshold, switching to a standby state for receiving the ping.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a coil;
a transmitting integrated circuit (IC) configured to wirelessly transmit power to an external device through the coil; and
a controller, comprising circuitry,
wherein the controller is configured to cause the electronic device to:
output a first ping and/or a second ping through the coil;
count an N value indicating a cumulative number of times the first ping and/or the second ping has been output;
based on the N value being less than a specified first threshold and based on a response to the first ping being received from the external device, perform first negotiation communication with the external device for first wireless charging, the first wireless charging being performed based on an alignment state between the electronic device and the external device using a magnet;
based on the N value being less than the first threshold and based on a response to the second ping being received from the external device, output the first ping and/or the second ping again; and
based on the N value being greater than or equal to the first threshold, perform second negotiation communication with the external device for second wireless charging independent of recognizing the magnet.

2. The electronic device of claim 1,
wherein the controller is configured to cause the electronic device to:
based on the N value being less than the specified first threshold and based on a response to the first ping and a response to the second ping not being received from the external device, switch to a standby state for detecting an approach of the external device.

3. The electronic device of claim 1,
wherein the magnet comprises a first magnet of the electronic device or a second magnet included in an accessory coupled to the electronic device.

4. The electronic device of claim 2,
wherein the controller is configured to cause the electronic device to: based on a request signal for third wireless charging being received from the external device while performing the second negotiation communication with the external device for the second wireless charging, perform third communication with the external device for the third wireless charging,
wherein the third wireless charging is low-speed wireless charging based on one-way communication in which data is transmitted from the external device to the electronic device, and
wherein a first power output by the electronic device according to the third wireless charging is lower than a second power output by the electronic device according to the second wireless charging.

5. The electronic device of claim 2,
wherein the controller is configured to cause the electronic device to:
based on the N value being less than the specified first threshold and based on a response to the first ping being received from the external device, identify a rectified voltage of the external device;
determine a K value indicating an alignment state between the coil and a second coil of the external device, based on the rectified voltage;
based on the determined K value being greater than or equal to a specified second threshold, perform the first negotiation communication with the external device; and
based on the determined K value being less than the second threshold, output the first ping and the second ping again.

6. The electronic device of claim 2,
wherein the controller is configured to cause the electronic device to:
based on the N value being less than the first threshold and based on a response to the second ping being received from the external device, transmit a misalignment signal indicating misalignment between the electronic device and the external device to the external device.

7. The electronic device of claim 1,
wherein an output power of the first ping is lower than an output power of the second ping.

8. An electronic device comprising:
a coil;
a wireless charging circuit configured to wirelessly receive power from an external device through the coil;
at least one processor, comprising processing circuitry; and
a memory configured to store instructions,
wherein the instructions, when executed by the processor, cause the electronic device to:
receive a ping of the external device through the coil;
upon receiving the ping, identify whether at least one processor is in an awake state;
based on at least one processor being in an awake state, determine whether a cover accessory comprising a magnet is coupled to the electronic device;
based on the cover accessory being coupled to the electronic device, count an N value indicating a cumulative number of times the ping has been received;
based on the N value being less than a specified first threshold, perform first negotiation communication with the external device for first wireless charging, the first wireless charging being performed based on an alignment state of the electronic device and the external device using a magnet; and
based on the N value being greater than or equal to the first threshold, perform second negotiation communication with the external device for second wireless charging independent of recognizing the magnet.

9. The electronic device of claim 8,
wherein the instructions, when executed by the processor, cause the electronic device to: perform third communication with the external device for third wireless charging based on at least one processor not being in the awake state,
wherein the third wireless charging is low-speed wireless charging based on one-way communication in which data is transmitted only from the external device to the electronic device, and
wherein a first power output by the electronic device according to the third wireless charging is lower than a second power output by the electronic device according to the second wireless charging.

10. The electronic device of claim 8,
wherein the instructions, when executed by the processor, cause the electronic device to:
identify a gain value indicating a ratio of a rectified voltage of the electronic device to an output voltage of the external device while performing the first negotiation communication with the external device;
based on the identified gain value, determine a K value indicating an alignment state of the coil and a second coil of the external device;
based on the determined K value being greater than or equal to a specified second threshold, perform the first negotiation communication with the external device; and
based on the determined K value being less than the second threshold, switch to a standby state for receiving the ping.

11. The electronic device of claim 8,
wherein the instructions, when executed by the processor, cause the electronic device to:
receive, from the external device, a misalignment signal indicating misalignment between the electronic device and the external device while performing the first negotiation communication with the external device; and
in response to the misalignment signal, output a notification indicating misalignment between the electronic device and the external device.

12. The electronic device of claim 11,
wherein the ping received from the external device comprises a first ping and/or a second ping,
wherein an output power of the first ping is lower than an output power of the second ping, and
wherein the misalignment signal is a signal received from the external device based on the electronic device performing the first negotiation communication in response to the second ping of the external device.

13. A method of driving an electronic device configured to wirelessly transmit power to an external device, the method comprising:
outputting a first ping and/or a second ping sequentially through a coil;
counting an N value indicating a cumulative number of times the first ping and/or the second ping has been output;
based on the N value being less than a specified first threshold and based on a response to the first ping being received from the external device, performing first negotiation communication with the external device for first wireless charging, the first wireless charging being performed based on an alignment state between the electronic device and the external device using a magnet;
based on the N value being less than the first threshold and based on a response to the second ping being received from the external device, outputting the first ping and/or the second ping again; and
based on the N value being greater than or equal to the first threshold, performing second negotiation communication with the external device for second wireless charging independent of recognizing the magnet.

14. The method of claim 13,
further comprising performing third communication with the external device for third wireless charging based on a request signal for the third wireless charging being received from the external device while performing the second negotiation communication with the external device for the second wireless charging,
wherein the third wireless charging is low-speed wireless charging based on one-way communication in which data is transmitted from the external device to the electronic device, and
wherein a first power output by the electronic device according to the third wireless charging is lower than a second power output by the electronic device according to the second wireless charging.

15. The method of claim 13, further comprising:
based on the N value being less than a specified first threshold and based on a response to the first ping being received from the external device, identifying a rectified voltage of the external device;
determining a K value indicating an alignment state between the coil and a second coil of the external device, based on the rectified voltage;
based on the determined K value being greater than or equal to a specified second threshold, performing the first negotiation communication with the external device; and
based on the determined K value being less than the second threshold, outputting the first ping and the second ping again.

16. The method of claim 13,
further comprising, based on the N value being less than the first threshold and based on a response to the second ping being received from the external device, transmitting a misalignment signal indicating misalignment between the electronic device and the external device to the external device.

17. The method of claim 13,
wherein an output power of the first ping is lower than an output power of the second ping.

18. A method of driving an electronic device configured to wirelessly receive power from an external device, the method comprising:
receiving a ping of the external device through a coil;
upon receiving the ping, identifying whether at least one processor is in an awake state;
based on at least one processor being in an awake state, determining whether a cover accessory comprising a magnet is coupled to the electronic device;
based on the cover accessory being coupled to the electronic device, counting an N value indicating a cumulative number of times the ping has been received;
based on the N value being less than a first threshold, performing first negotiation communication with the external device for first wireless charging, the first wireless charging being performed based on an alignment state of the electronic device and the external device using a magnet; and
based on the N value being greater than or equal to the first threshold, performing second negotiation communication with the external device for second wireless charging independent of recognizing the magnet.

19. The method of claim 18,
further comprising performing third communication with the external device for third wireless charging based on at least one processor not being in the awake state,
wherein the third wireless charging is low-speed wireless charging based on one-way communication in which data is transmitted from the external device to the electronic device, and
wherein a first power output by the electronic device according to the third wireless charging is lower than a second power output by the electronic device according to the second wireless charging.

20. The method of claim 18, further comprising:
identifying a gain value indicating a ratio of a rectified voltage of the electronic device to an output voltage of the external device while performing the first negotiation communication with the external device;
based on the identified gain value, determining a K value indicating an alignment state of the coil and a second coil of the external device;
based on the determined K value being greater than or equal to a specified second threshold, performing the first negotiation communication with the external device; and
based on the determined K value being less than the second threshold, switching to a standby state for receiving the ping.
